(19) United States
(12) Patent Application Publication
(10) Pub. No.: US 2008/0023166 A1
(43) Pub. Date: Jan. 31, 2008

(54) Device for the Production and/or Treatment of a Strip or Sheet of Material

(76) Inventors: Roland Mayer, Heidenheim (DE); Ulrich Begemann, Heidenheim (DE)

Correspondence Address: TAYLOR & AUST, P.C., P.O. Box 560, 142. S Main Street, Avilla, IN, 46710, US

(21) Appl. No.: 10/578,422

(22) PCT Filed: Oct. 20, 2004
(86) PCT No.: PCT/EP04/52580

§ 371 Date: Jan. 29, 2007

(30) Foreign Application Priority Data
Nov. 5, 2003 (DE) 10351623.9

(51) Int. Cl. D21F 5/00; H01M 8/04

(52) U.S. Cl. 162/207; 162/262

(57) ABSTRACT

The invention relates to a machine for the production and/or treatment of strip or sheet material (20), particularly paper or cardboard, which is connected to at least one associated fuel cell (26) such that the thermal energy produced by the fuel cell unit (26) can be supplied to the machine as operating energy. Thermal energy produced by the fuel cell (26) can be supplied to at least one heating section (10) of the machine, said section being embodied in such a way that it can heat or be heated during an operating state of the machine.

### CROSS-REFERENCE TO RELATED APPLICATIONS

The present application claims priority under 35 U.S.C. §119 of German Patent Application No. 103 51 623.9 filed on 5 Nov. 2003, and International Application PCT/EP2004/052580, filed 20 Oct. 2004, the disclosures of which are expressly incorporated by reference herein in their entirety.

### BACKGROUND OF INVENTION

1. Field of the Invention

The present invention relates to a machine for the production and/or treatment of web or sheet material, in particular paper or board.

2. Discussion of Background Information

Such machines include, for example, paper machines which are known from the paper industry. In general, paper machines substantially comprise a headbox, in which the raw paper stock is supplied and distributed uniformly, a wire section, in which the sheet is formed by a filtration process, a press section, in which stock water contained in the material web is driven out by means of pressure, a drying section for drying the material web, a surface finishing section, for example a coating device, for calendering, coating, etc. the material web, and a reeler for the finished material web. Depending on the process used for surface finishing, further drying devices can be provided in this part of the plant. Furthermore, partial processes during the production and/or treatment of web or sheet material are often also carried out in separate plants. For example, an off-line coating device can be used for surface coating a paper web, or a calender can be used for calendering.

In general, machines of the type mentioned at the beginning contain components which operate with an operating temperature above room temperature (heated components) or provide thermal energy for heating operating media, for example an air stream or a coating medium (heating components). For drying devices, for example in the drying section of the surface finishing section, the use of drying cylinders is in particular common, in which a material web to be dried runs through an arrangement of drying cylinders. The drying cylinders are in turn run around over about two thirds by a dryer felt, which picks up the moisture from the material web and is dried on a felt dryer in a return region of the arrangement. The material web to be dried is threaded in between the dryer felt and the heated drying cylinders and therefore brought into close contact with the respective drying cylinder, on the one hand, and the dryer felt, on the other hand (contact drying). In order to heat the drying cylinders, it is known to use steam, which is taken from another section of the paper machine as process steam or is provided with the aid of electrical energy, for example by using force-heat coupling. Furthermore, the use of gas-operated steam generators is known.

To dry a moving material web, hot air dryers are additionally used, which heat an air stream to a temperature of several hundred degrees Celsius and apply it to the material web to be dried. Such hot air dryers are operated with gas and, as compared with drying cylinder arrangements, have various known advantages, such as the possibility of non-contact web guidance, a higher power density and a higher operating speed. However, they are associated with higher operating and procurement costs.

### SUMMARY OF THE INVENTION

It is an object of the present invention, in a machine of the type mentioned at the beginning which has at least one heating or heated section, to improve the operation of these heating sections, in particular with regard to the total energy balance and the exhaust gas emission of the machine. A further object of the invention is to provide drying devices for a machine of the aforementioned type which can be operated in an effective and energy-saving manner.

In order to achieve at least one of these objects, the present invention provides for the machine to be connected to at least one associated fuel cell unit in such a way that thermal energy produced by the fuel cell unit can be supplied to the machine as operating energy.

A fuel cell is used in a manner known per se for converting chemical energy into electrical energy. The classic fuel cell comprises an anode and a cathode, to which hydrogen and oxygen are supplied as energy carriers. Within the cell, the hydrogen oxidizes, liberating water and free charges, which are provided by the electrodes as electrical energy in the form of a direct current. Fuel cells used for power generation can achieve an efficiency of more than 50% nowadays.

A type of fuel cells preferably used to obtain power operates at an operating temperature of about 600° C.-1000° C. If, then, in accordance with the invention, the associated thermal energy is supplied to the machine for the production and/or treatment of web or sheet material, then this energy can be incorporated into the energy balance of the machine. In addition, during the operation of fuel cell systems, substantially only hot air and water vapor are produced as waste gases, so that polluting the surroundings of the machine and the environment is avoided.

In addition, it may be particularly effective and economical if, in addition to the thermal energy, the electrical energy produced by the fuel cell can also be supplied to the machine. Since, in this way, the predominant part of the energy produced by the fuel cell is provided as energy that can be used by the machine, such a combination of a fuel cell unit and a machine for the production and/or treatment of web or sheet material is able to provide an overall system with a particularly high efficiency.

In order to be able to use the thermal energy provided by the fuel cell unit directly and to avoid energy losses in the conversion of the thermal energy into other forms of energy, it will generally be preferred if it is possible for at least one heating section of the machine, which is designed to heat or be heated during an operating state of the machine, to be supplied with thermal energy produced by the fuel cell unit as operating energy.

To this end, it is proposed that waste air discharged by the fuel cell unit to be supplied to the at least one heating section. The waste air from the fuel cell has a temperature of about 300° C. to 600° C. and therefore, in a simple manner, constitutes a transfer medium for the transport of the thermal energy from the fuel cell to the machine.

In a first embodiment of the present invention, provision is made for the at least one heating section or at least one of the heating sections to comprise a drying device, through which the web or sheet material can be guided and/or along which the web or sheet material can be guided, the drying device comprising at least one heatable drying cylinder on which the web or sheet material can be guided directly or resting on a dryer felt running on the drying cylinder, it being possible for thermal energy produced by the fuel cell unit to be supplied to the drying cylinder. The thermal energy for heating the drying cylinders as needed by a drying device having heatable drying cylinders can thus be supplied in an effective way by a fuel cell unit.

As a simple technical implementation of the machine according to the first embodiment of the invention, it is proposed that waste air discharged by the fuel cell unit flows through the at least one drying cylinder and/or a fluid, to which thermal energy produced by the fuel cell unit, in particular waste air discharged by the fuel cell unit, can be supplied, flows through the drying cylinder. In this way, uniform and continuous heating of the drying cylinders is ensured.

According to a second embodiment of the present invention, a machine constructed in accordance with the invention comprise a hot gas drying device, through which the web or sheet material can be guided and/or along which the web or sheet material can be guided, the hot gas drying device operating on the basis of drying gas which can be applied to the web or sheet material, it being possible for the drying gas to be provided on the basis of thermal energy discharged by the fuel cell unit. In this way, the drying gas can be heated up to an operating temperature by using the thermal energy of the fuel cell unit in an economic manner and without significant pollutant emission.

To provide the drying gas, it is conceivable that the waste air discharged by the fuel cell unit can be combined with gas provided by a gas supply, by which means the transfer of heat from the fuel cell unit to the gas is achieved in a particularly simple way by using the waste air. Alternatively or additionally, waste air discharged by the fuel cell unit can be supplied to a heat exchanger, which is designed to heat gas provided by a gas supply and therefore to provide it as drying gas. In this variant, the paths of the waste air and of the drying gas can therefore be separate from each other. Furthermore, however, it is also conceivable that the waste air discharged by the fuel cell unit can be supplied to the hot gas drying device as drying gas. This variant is structurally particularly simple and therefore cost-effective, since the provision of a separate drying gas and of a heat exchanger is not necessary.

For a machine according to the first or second embodiment and in general for a machine according to the present invention, it will be advantageous to arrange the fuel cell unit in the vicinity of, preferably at a distance of less than approximately 100 meters from, at least one heating section of the machine. Losses of thermal energy, in particular in conduits for heat transfer media which transfer the thermal energy from the fuel cell to the heating section of the machine, can be reduced in this way.

Moreover, the invention also provides a combination of a machine according to the type described above with the associated fuel cell unit.

In addition, the invention provides a method for the production and/or treatment, in particular for the heating and/or drying, of web or sheet material by using a machine, in particular a machine as claimed in one of claims 1 to 11, in which the machine is supplied with thermal (and, if appropriate, also electrical) energy produced by a fuel cell unit. In this way, for example when drying a material web, the energy balance can be improved and loading of the environment and possibly costs can be reduced.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a drying device combined with a fuel cell unit for a machine according to the first embodiment of the present invention,

FIG. 2 shows a drying device for a machine according to the second embodiment of the present invention,

FIG. 3 shows a further exemplary embodiments of drying devices for a machine according to the invention, and

FIG. 4 shows a further exemplary embodiments of drying devices for a machine according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

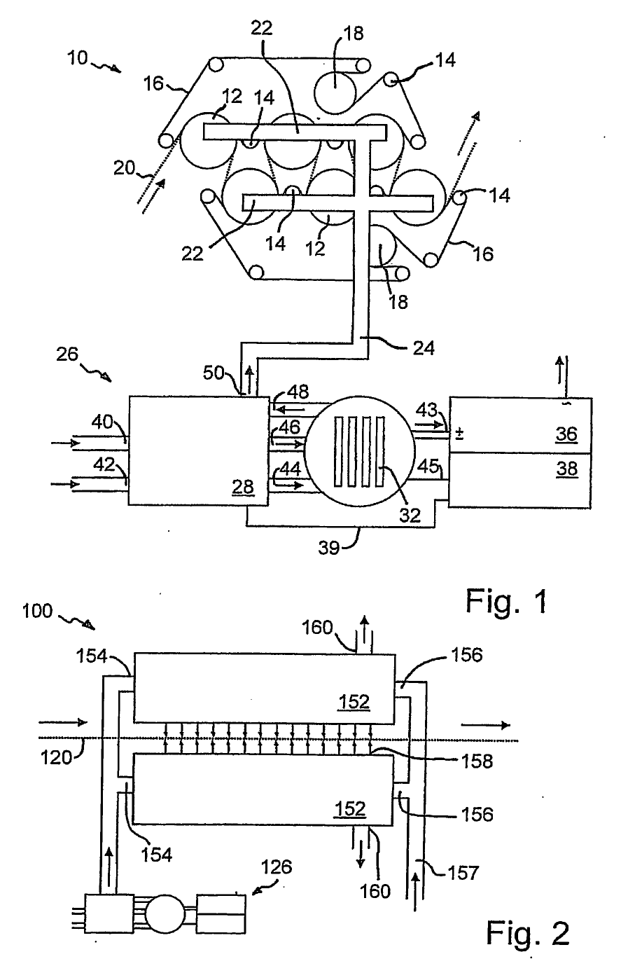

FIG. 1 shows a drying device, designated generally by 10, for a paper machine according to the first embodiment of the present invention. The drying device 10 comprises an arrangement of drying cylinders 12 in two mutually parallel rows. Around the drying cylinders 12 of a row, with the aid of felt guide rolls 14, a dryer felt 16 is guided in such a way that it runs around approximately two thirds of each drying cylinder 12 and is subsequently guided around a felt dryer 18. A material web section 20 to be dried enters the drying device 10 on the side of the latter on the left in FIG. 1, in that it runs between the dryer felt 16 of the first row and the first drying cylinder 12 of the first row. After that, the material web section 20 runs around a first drying cylinder 12 of the second row, once more enclosed between the drying cylinder 12 on one side and a second dryer felt 16 of the second row on the other side. In this way, the material web section 20 to be dried runs alternately around the drying cylinders of the first and second row and, in the process, is in each case pressed by the corresponding dryer felt 16 against the circumferential surface of the drying cylinders 12, by which means the dryer felt 16 extracts moisture from the material web 20. The dryer felt 16 is for its part dried in a felt dryer 18 during its return run.

To increase the drying capacity of drying devices with drying cylinders, it is known to heat the drying cylinders. In the drying device 10 of the first embodiment of the present invention, each drying cylinder 12 is connected to a feed duct 22, via which a heating medium can be supplied to the respective drying cylinder 12. According to FIG. 1, a feed duct 22 is provided for each row of drying cylinders 12 in each case, the two feed ducts 22 being connected to a main feed line 24 which, in turn, is connected to a fuel cell unit 26.

In the example shown in FIG. 1, the main feed line 24 is charged with the waste air from the fuel cell unit 24, which then flows into the feed ducts 22 at a temperature of several hundred degrees Celsius and is led directly from there into the individual drying cylinders 12. There, the waste air supplied gives up part of its thermal energy to the drying cylinders 12, for example to their walls, which means that the drying cylinders 12 are heated to a specific temperature or kept at a specific temperature. After the waste air has given up at least part of its thermal energy to the drying cylinders 12, it flows out of the drying cylinders 12 through openings, not shown, and can then be led away or else reused.

In addition to the example shown in FIG. 1 with direct supply of the waste air from the fuel cell unit 26 to the drying cylinders 12, however, it is also conceivable to use a heat exchanger, whose primary side is heated by the hot waste air and whose secondary side is in thermal contact with the drying cylinders 12 via a heat transfer medium, in order to transfer the thermal energy from the waste air to the drying cylinders 12. It is then also conceivable likewise to provide any electrical energy which may possibly be needed to drive pumps, motors or the like for moving the waste air or the heat transfer medium by means of the fuel cell unit 26.

In connection with the invention, use can advantageously be made of a fuel cell unit having a high temperature fuel cell, whose operating temperature lies in the range from about 600° C. to about 1000° C., so that the waste air discharged by the fuel cell has a temperature from about 300° C. to about 600° C. An example of such a fuel cell unit 26, illustrated schematically in FIG. 1, comprises a gas preparation unit 28, a central unit 30 with fuel cell stacks 32 arranged therein and an electrical unit 34 having an energy conditioning unit 36 and a control/regulating unit 38. The gas preparation unit is supplied with fresh air via a fresh air inlet 40 and with natural gas, town gas or another suitable fuel gas via a gas inlet 42. The gas supplied via the gas inlet 42 is prepared in the gas preparation unit, in particular desulfurized and preheated, and subsequently supplied to the central unit 30 as process gas via a gas line 44. At the same time, the central unit 30 is supplied via a fresh air line 46 with the fresh air supplied to the gas preparation unit 28 via the fresh air inlet 40. In the central unit, process gas and atmospheric oxygen react at the electrodes of the fuel cell stack 32, forming electric charges and thermal energy.

The thermal energy produced is led out of the central unit 30 in the form of hot waste air and, via a waste air line 48, passes back to the gas preparation unit 28, from which it emerges through a waste air outlet 50. Depending on whether part of the thermal energy of the hot waste air is used in the gas preparation unit 28 for preheating fuel gas, the waste air leaves the fuel cell unit 26 at a temperature of about 400° C. or, respectively, at a temperature of about 600° C.

The charges produced on the electrodes of the fuel cell during the combustion process are led away via a power line 43 and provided to the energy conditioning unit 36 of the electrical unit 34. The energy conditioning unit 36 can convert the direct current supplied by the fuel cell into an alternating current if required, which can ultimately be used by a load. The operation of the fuel cell unit 26 is controlled and monitored by a control/regulating unit 38 which, for this purpose, is connected to the central unit 30 and the gas preparation unit 28 via lines 45 and 39, respectively.

In FIG. 2, a hot gas drying device 100 for a machine according to the second embodiment of the present invention is illustrated. The hot gas drying device 100 comprises two blower units 152, to which hot waste air from a fuel cell unit 126, indicated only schematically, can in each case be supplied via hot gas connections 154, and air can be supplied via fresh air connections 156. In the blower units 152, the air is brought into thermal contact with the hot waste gas via a heat exchanger and heated up to an operating temperature. The heated air then flows out of nozzles 158 into the blower units 152 as drying gas and acts on a material web 120 guided through between the blower units 152. The drying of the material web 120 is thus carried out without contact in a stream of hot drying gas, using the thermal energy provided by the fuel cell unit 126. After at least part of the thermal energy of the waste air has been transferred to the air supplied, cooled waste air leaves the blower unit 152 via outlets 160.

It should be mentioned that the blower units 152 can also be formed in such a way that the fresh air supplied is mixed in the blower units 152 with the waste air supplied from the fuel cell unit, and the gas mixture produced in this way leaves the blower units 152 through the nozzles 158 as drying gas in order to act on the material web 120. In addition, it would be conceivable to dispense entirely with a fresh air feed line and to arrange for the waste air from the fuel cell unit 126 to emerge directly from the nozzles 158 of the blower units 152 in order to dry the material web 120 directly in the stream of hot waste air.

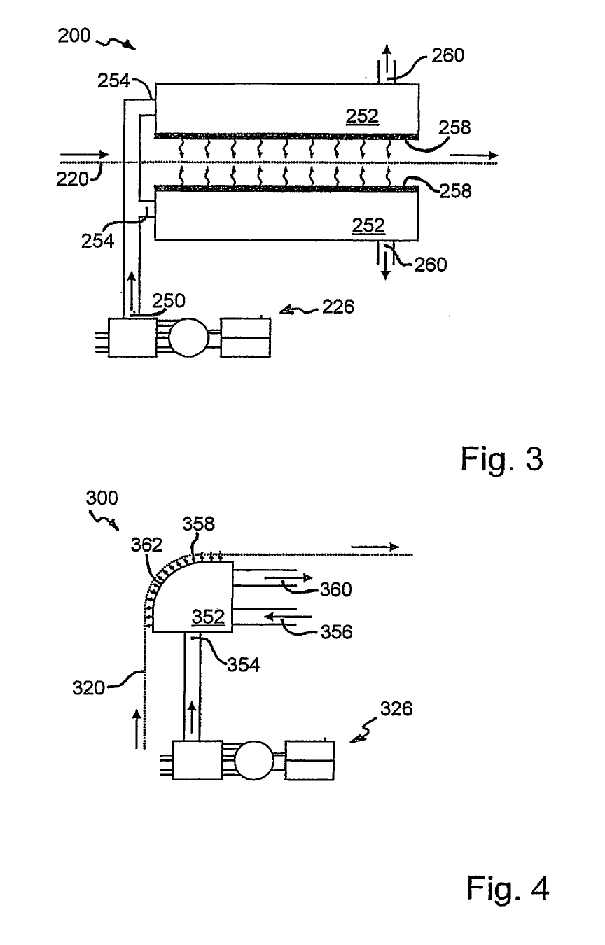

FIG. 3 illustrates an exemplary embodiment of the present invention, in which an infrared drying device 200 for a machine, for example a paper machine, is connected to the waste air outlet 250 of a fuel cell unit 226, merely indicated in FIG. 3. The infrared drying unit 200 comprises two infrared radiant heaters 252 having radiant surfaces 258 which face a material web 220 to be dried guided through between the infrared radiant heaters 252.

Via hot gas connections 254, the infrared radiant heaters 252 are supplied with hot waste air from the fuel cell unit 226, which then gives up part of its thermal energy to the infrared radiant heaters 252 and then leaves the infrared radiant heaters 252 via outlets 260. The waste air from the fuel cell unit 226 is thus brought into thermal contact with the infrared radiant heaters 252 in order to heat up the radiant surfaces 258 of the infrared radiant heaters 252 to an operating temperature. The radiant surfaces 258 then emit thermal radiation in the direction of the material web 220 to be dried, by which means the latter is heated and dried. A further example of a drying device for a machine according to the present invention is shown by FIG. 4. In the drying device 300, a blower unit 352 is supplied via a hot gas connection 354 with hot waste air from a fuel cell unit 326, which, in a manner analogous to the drying device 100 of FIG. 2, heats fresh air there, which has been supplied to the blower unit 352 via a fresh air connection 356. The fresh air thus heated to an operating temperature then flows out of the blower unit 352 through nozzles 358 and acts on a material web 320 guided past the blower unit 352. Cooled waste air leaves the blower unit 352 via an outlet 360.

As opposed to the drying device 100 of FIG. 2, the surface 362 facing the material web 320, in which surface the nozzles 358 are also arranged, has a convex curvature, so that the running path of the material web 320 exhibits a curvature in this region. In this region, the material web 320 runs on an air bed, which is formed by the hot drying gas emerging from the nozzles 358. This principle relating to deflecting a moving material web is known as an airturn. In that, now, according to the present invention, a blower unit 352 constructed in analogy with the principle of an airturn is charged with hot waste air from a fuel cell unit 326, the hot air drying device according to the invention can also be used simultaneously for material web deflection.

Irrespective of the practical implementation of the invention in accordance with the embodiments described or other conceivable embodiments or exemplary embodiments of the invention, it will be expedient to supply the electrical energy provided by the fuel cell unit 26, 126, 226, 326 to the machine directly as direct current or as alternating current, in order thus to use the total energy given up before the fuel cell unit 26, 126, 226, 326 as completely as possible and thus to optimize the total energy balance of the system comprising fuel cell unit 26, 126, 226, 326 and the machine.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A machine that produces and/or treats at least one of a web and sheet material comprising:
a fuel cell:
wherein the machine is connected to the fuel cell such that thermal energy produced by the fuel cell is supplied to the machine as operating energy.

2. The machine of claim 1, wherein at least one heating section of the machine is supplied with thermal energy produced by the fuel cell as operating energy.

3. The machine of claim 2, wherein waste air discharged by the fuel cell is supplied to the at least one heating section.

4. The machine of claim 3; wherein the at least one heating section comprises a drying device, through which one of the web and the sheet material is at least one of guided and along which the one of the web and sheet material can be guided, the drying device comprising at least one heatable drying cylinder on which the one of the web and the sheet material can be one of guided directly and resting on a dryer felt running on the drying cylinder, and wherein thermal energy produced by the fuel cell is supplied to the drying cylinder.

5. The machine of claim 4, wherein the waste air discharged by the fuel cell flows through at least one of the at least one drying cylinder and a fluid, to which thermal energy produced by the fuel cell in the form of the waste air discharged by the fuel cell, is supplied, flows through the drying cylinder.

6. The machine of claim 1, further comprising a hot gas drying device through which the at least one of the web and the sheet material is at least one of guided and along which the web or the sheet material can be guided, the hot gas drying device operating on the basis of a drying gas that is applied to the web or the sheet material, the drying gas provided on the basis of thermal energy discharged by the fuel cell.

7. The machine of claim 6, wherein waste air discharged by the fuel cell is combined with gas provided by a gas supply, in order to provide the drying gas.

8. The machine of claim 7, wherein the waste air discharged by the fuel cell is supplied to a heat exchanger, is the heat exchanger designed to heat gas provided by a gas supply and provide the heated gas as the drying gas.

9. The machine of claim 7, wherein the waste air discharged by the fuel cell is supplied to the hot gas drying device as drying gas.

10. The machine of claim 1, wherein the fuel cell is arranged in at least one of the vicinity of and at a distance of less than approximately 100 meters from the at least one heating section of the machine.

11. (canceled)

12. A method for at least one of heating and drying, of a web and a sheet material by using a machine, comprising the step of supplying the machine with thermal energy produced by a fuel cell.

13. The method of claim 12, in which the machine is further supplied with electrical energy produced by the fuel cell.
